(19) United States
(12) Patent Application Publication
(10) Pub. No.: US 2004/0236542 A1
(43) Pub. Date: Nov. 25, 2004

(54) Computer-aided structure analysis and design graphic display device that displays joint status using numerical data

(75) Inventors: Dong-Seok Kim, Incheon-si (KR); Jung-Hwan Jeong, Gyeonggi-do (KR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: FEA SOFT CO., LTD, Yusong-gu (KR)

(21) Appl. No.: 10/850,415

(22) Filed: May 20, 2004

(30) Foreign Application Priority Data
May 21, 2003 (KR) 10-2003-0032341

(51) Int. Cl. G06F 17/50

(52) U.S. Cl. 703/1

(57) ABSTRACT

The present invention discloses a computer-aided structure analysis and design graphic display device that standardizes a joint inserted into a structure, which is analyzed and designed, and graphically displays the status of the joint, to thereby allow a user to easily recognize the joint status. The computer-aided structure analysis and design graphic display device includes: database for storing a plurality of joints and variables for defining the statuses of the joints; input devices by which numerical data is input such that the numerical data corresponds to each of the variables; display devices for varying the statuses of the joints on the basis of the numerical data input through the input devices and displaying the varied statuses; and means for making the status of a dummy correspond with the displayed joint status.

### FIELD OF THE INVENTION

The present invention relates to a computer-aided structure analysis and design graphic display device and method, and more particularly, to a computer-aided structure analysis and design graphic display device that standardizes a joint inserted into a structure, which is analyzed and designed, and graphically displays the status of the joint, to thereby allow a user to easily recognize the joint status.

### BACKGROUND OF THE INVENTION

Computer-aided engineering (CAE) is widely used to analyze structures such as vehicles, ships, planes, bridges, buildings and so on. The CAE can collectively process complicate mathematical calculations (for example, finite element method) for a three-dimensional structure designed by a user and graphically display the processed result. Accordingly, the CAE is used in a variety of applications.

In the case where a conventional CAE apparatus analyzes a car, for instance, the inside of the car is full of joints (for example, link connections, universal joints, welding connections, revolute joints and so on) that define a large number of components of the car and connections of them. When a computer analyzes the car through numerical analysis, various variables that define motions of the joints and the equation of motion that is constructed using the variables are used.

FIG. 5 shows a list of representative coordinate systems used in Prepost of a computer-aided analysis and design graphic display device for various joints. As shown in FIG. 5, there are various type of joints including joint-free, a user-defined joint, a revolute joint, a spherical or ball and socket joint, a universal joint, a translation joint, and a rigid connection. Coordinate systems that respectively define the various joints are shown at the left side of FIG. 5.

However, though the variables and the equation of motion are suitable for calculations by the computer, it is difficult for a user to intuitively recognize the statuses of the joints through the variables and the equation of motion. That is, the user cannot easily become aware of the current statuses or positions of components or joints because three-dimensional position data or angle data of the joints is simply numerically displayed as a calculation result. This problem becomes more serious when a complicated structure is repeatedly magnified and rotated.

### SUMMARY OF THE INVENTION

Accordingly, the present invention has been made to resolve the above mentioned problems, and it is an object of the present invention is to provide a computer-aided structure analysis and design graphic display device for displaying a joint status using numerical data, which receives numerical data of variables that define a joint and graphically displays the operation status of the joint on a window screen, to thereby allow a user to visually perceive the joint status.

Another object of the present invention is to provide a computer-aided structure analysis and design graphic display device for displaying a joint status using numerical data, by which, even if a displayed structure is repeatedly reduced, magnified, rotated and moved on a screen, when a specific portion of the structure is clicked using a mouse, the current status of a joint equivalent to the portion is displayed.

To accomplish the above objects, in one aspect of the present invention, a computer-aided structure analysis and design graphic display device that displays a joint status using numerical data includes: database means for storing a plurality of joints and variables for defining the statuses of the joints; input means by which numerical data is input such that the numerical data corresponds to each of the variables; display means for varying the statuses of the joints on the basis of the numerical data input through the input means and displaying the varied statuses; and matching means for making the status of a dummy match with the displayed joint status.

Preferably, the computer-aided structure analysis and design graphic display device further includes selecting means for selecting one of the plurality of joints stored in the database.

More preferably, the computer-aided structure analysis and design graphic display device further includes a designating means for, when a specific portion of the dummy is designated, allowing the display means to display a joint status corresponding to the specific portion.

The specific portion of the dummy is designated by a clicking event of a mouse.

Data about a user-defined joint, a revolute joint, a spherical or ball and socket joint, a universal joint, a translation joint and rigid connection may be stored in the database means.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates a composition a main window of a computer-aided structure analysis and design graphic display device that displays a joint status using numerical data according to the present invention;

FIG. 2 shows variables for displaying the status of a universal joint according to an embodiment of the present invention;

FIG. 3 illustrates a first example of the joint display window shown in FIG. 1;

FIG. 4 illustrates a second example of the joint display window shown in FIG. 1; and

FIG. 5 shows a list of coordinate systems of various joints used in a computer-aided structure analysis and design graphic display device.

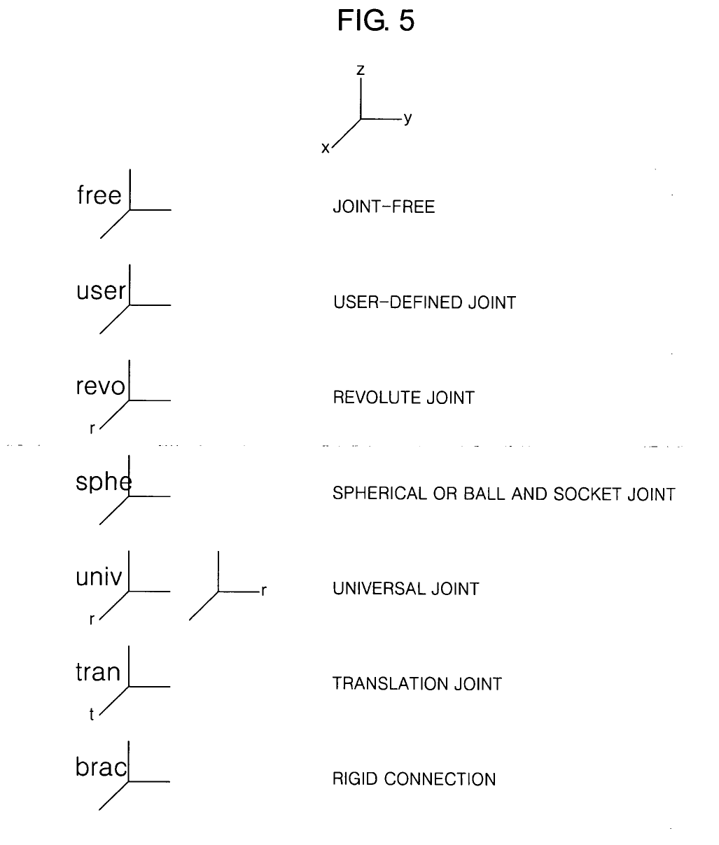

### DETAILED DESCRIPTION OF THE PREFERRED EMBODIMENTS

Reference will now be made in detail to the preferred embodiments of the present invention, examples of which are illustrated in the accompanying drawings.

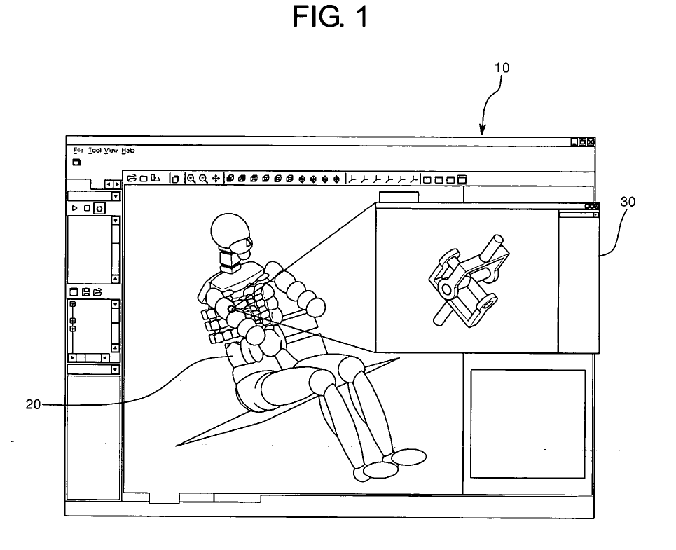

FIG. 1 illustrates a composition a main window 10 of a computer-aided structure analysis and design graphic display device that displays a joint status using numerical data according to the present invention. In FIG. 1, it shows a dummy 20 used for the analysis of a car collision, and the arm joint of the dummy 20 corresponds to a universal joint 30.

As shown in FIG. 1, when a user clicks the arm joint of the dummy 20 on the main window 10 using a mouse (not shown), a joint display window 30 is displayed. Since the arm joint of the dummy 20 is previously matched with the universal joint 30, the universal joint 30 is displayed such that it is folded at an angle corresponding to a folded angle of the arm joint of the dummy 20.

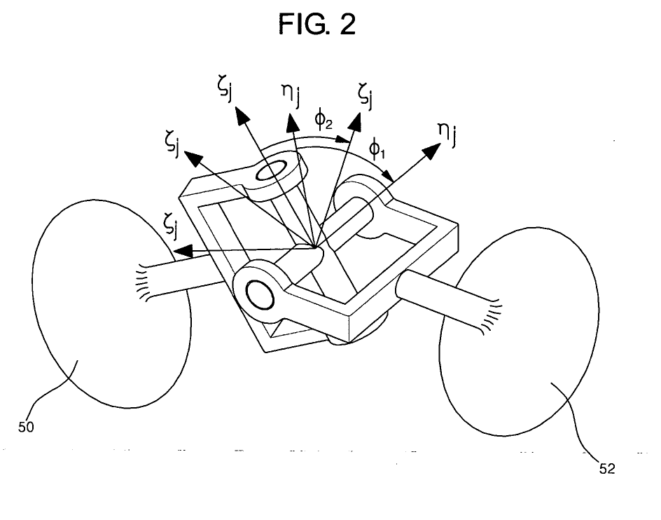

FIG. 2 shows variables for displaying the status of the universal joint according to an embodiment of the present invention. As shown in FIG. 2, when the universal joint connects first and second axes 50 and 52 to each other, two angle variables φ₁ and φ₂ are needed in order to define the position of the universal joint. That is, although the universal joint is repeatedly reduced, magnified, rotated and moved on the screen, the position of the universal joint can be displayed using the two angle variables φ₁ and φ₂. In the case where joints other than the universal joint are used, variables should be defined depending on a degree of freedom of each joint.

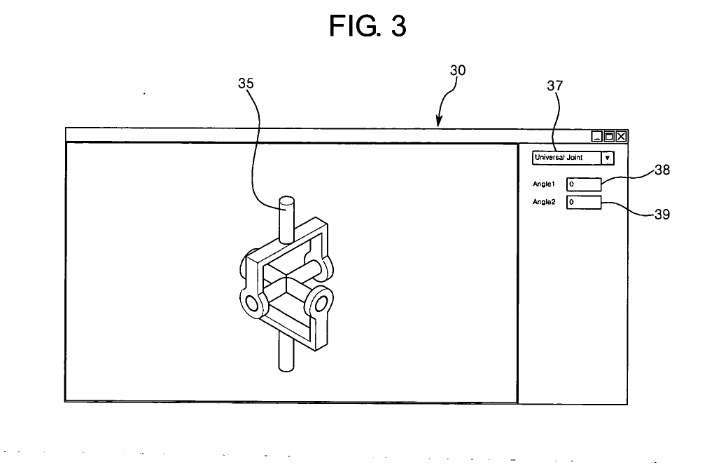

FIG. 3 illustrates a first example of the joint display window 30 shown in FIG. 1. As shown in FIG. 3, when a universal joint is selected through a joint select window 37, “0” is input to a first input window 38 as the first angle variable φ₁ and “0” is input to a second input window 39 as the second angle variable φ₂, the universal joint 35 having the first and second axes which are located on a straight line is displayed.

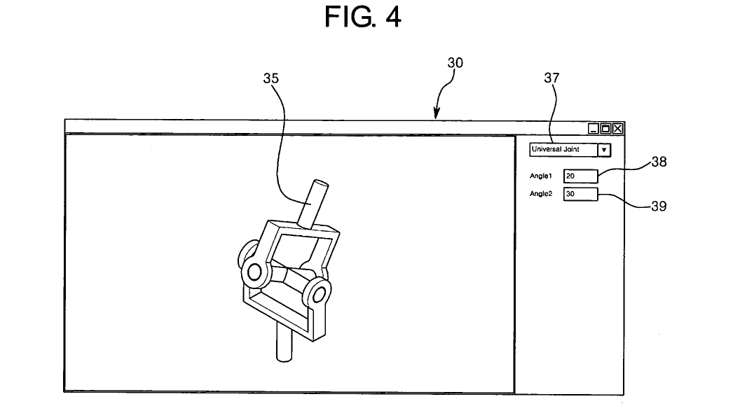

FIG. 4 illustrates a second example of the joint display window 30 shown in FIG. 1. As shown in FIG. 4, when “20” is input to the first input window 38 as the first angle variable φ₁ and “30” is input to the second input window 39 as the second angle variable φ₂, the universal joint 35 having the first and second axes which are respectively rotated by corresponding angles is displayed. Accordingly, a user can easily recognize the current status of the dummy 20 because he/she can visually confirm the image of the dummy, graphically displayed on the joint display window 30.

A method of operating the computer-aided structure analysis and design graphic display device that displays a joint status using numerical data will now be explained in detail.

First of all, the user displays the dummy 20 on the main window 10 shown in FIG. 1, designates the arm joint portion of the dummy 20, and then calls the joint display window 30. Subsequently, the user selects the universal joint 35 through the joint select window 37 and matches the universal joint 35 with the arm joint of the dummy. Then, the two angle variables φ₁ and φ₂ are read out from a variable field of a database and displayed as shown in FIG. 3. The angle variables are previously defined in the variable field together with the universal joint 35.

When the user inputs specific angle variables φ₁ and φ₂, as shown in FIG. 4, the universal joint 35 is rotated in response to the input angle variables. Simultaneously, the arm joint of the dummy 20 displayed on the main window 10 is rotated. Accordingly, the user can input various angle variables through the joint display window 30 and visually confirm a variation in the status of the dummy 20 in real time.

If the user wants to change the universal joint to a different joint, he/she clicks the arm joint of the dummy to call the joint display window 30 and then selects a desired joint through the joint select window 37.

The operation after the completion of a computer-aided analysis will now be explained.

In the case of the analysis of a car collision, for instance, the dummy 20 shown in FIG. 1 has a changed posture in response to a calculation result after the collision. Here, the user can click the arm joint having a changed form to call the joint display window 30 as shown in FIG. 4. Then, the universal joint 35 rotated to correspond to the changed form of the arm joint is displayed and the two angle variables φ₁ and ¢2 are numerically displayed in the input windows 38 and 39, respectively. Accordingly, the user can visually recognize the status of the arm joint and the angle variables. Even when the dummy 20 is repeatedly magnified, reduced, rotated and moved, the user can easily confirm the joint status.

While the present invention has described only the analysis of a car collision and the universal joint in the above embodiment, it can also be applied to various fields in which the analysis of structures such as ships, planes, bridges, buildings, towers, and electronic appliances is required.

Furthermore, it is possible to define joint-free, a user-defined joint, a revolute joint, a spherical or ball and socket joint, a translation joint, a rigid connection in a database and use them, in addition to the universal joint.

Moreover, application program to which the present invention is applied can be embedded as a library in a structure analysis program (or computer-aided structure design and analysis graphic display device), or constructed in a separate library and sold. Otherwise, the application program may have a component form merged into a main program if required.

As described above, according to the computer-aided structure analysis and design graphic display device that displays a joint status using numeral data of the present invention, data of variables for defining a joint can be numerically input and the status of the joint depending on the input variables can be graphically displayed on a window screen in real time. Thus, a user (or designer) can visually perceive the joint status. Therefore, the user can easily handle a structure even if the structure is very complicated.

Moreover, even if a displayed structure is repeatedly reduced, magnified, rotated and moved on the screen, when a specific portion of the structure is clicked, the status of a joint equivalent to the portion, which corresponds to the current status of the portion, is displayed. Accordingly, the user can correctly recognize the joint irrespective of the direction in which the user watches the joint.

The forgoing embodiments are merely exemplary and are not to be construed as limiting the present invention. The present invention can be readily applied to other types of apparatuses. The description of the present invention is intended to be illustrative, and not to limit the scope of the claims. Many alternatives, modifications, and variations will be apparent to those skilled in the art.

That which is claimed is:

1. A computer-aided structure analysis and design graphic display device that displays a joint status using numerical data, comprising:
database means for storing a plurality of joints and variables for defining the statuses of the joints;
input means by which numerical data is input such that the numerical data corresponds to each of the variables;
display means for varying the statuses of the joints on the basis of the numerical data input through the input means and displaying the varied statuses; and
matching means for making the status of a dummy match with the displayed joint status.

2. The computer-aided structure analysis and design graphic display device as claimed in claim 1, further comprising selecting means for selecting one of the plurality of joints stored in the database.

3. The computer-aided structure analysis and design graphic display device as claimed in claim 1, further comprising designating means for, when a specific portion of the dummy is designated, allowing the display means to display a joint status corresponding to the specific portion.

4. The computer-aided structure analysis and design graphic display device as claimed in claim 3, wherein the designating means is designated by a clicking event of a mouse.

5. The computer-aided structure analysis and design graphic display device as claimed in claim 1, wherein data about a universal joint is stored in the database means.

6. The computer-aided structure analysis and design graphic display device as claimed in claim 5, wherein, when the universal joint stored in the database means is selected, two angle variables φ₁ and φ₂ are read out from a variable field of the database, and the position of the universal joint is sufficiently displayed only using the two angle variables φ₁ and φ₂, the angle variables being defined in the variable field together with the universal joint.

7. The computer-aided structure analysis and design graphic display device as claimed in claim 1, wherein data about a revolute joint is stored in the database means.

8. The computer-aided structure analysis and design graphic display device as claimed in claim 1, wherein data about a spherical or ball and socket joint is stored in the database means.

9. The computer-aided structure analysis and design graphic display device as claimed in claim 1, wherein data about a user-defined joint is stored in the database means.

10. The computer-aided structure analysis and design graphic display device as claimed in claim 1, wherein data about a translation joint is stored in the database means.

11. The computer-aided structure analysis and design graphic display device as claimed in claim 1, wherein data about a rigid connection is stored in the database means.

12. The computer-aided structure analysis and design graphic display device as claimed in claim 1, wherein data about joint-free is stored in the database means.
